(19) United States
(12) Patent Application Publication
(10) Pub. No.: US 2004/0225473 A1
(43) Pub. Date: Nov. 11, 2004

(54) Fraud score calculating program, method of calculating fraud score, and fraud score calculating system for credit cards

(75) Inventors: Osamu Aoki, Tokyo (JP); Mikinori Seita, Tokyo (JP)

Correspondence Address: George A. LOUD, P.C., LORUSSO, LOUD & KELLY, 3137 Mount Vernon Avenue, Alexandria, VA, 22305, US

(73) Assignee: INTELLIGENT WAVE, INC.

(21) Appl. No.: 10/747,098

(22) Filed: Dec. 30, 2003

(30) Foreign Application Priority Data
May 7, 2003 (JP) 2003-129410

(51) Int. Cl. G06F 15/00

(52) U.S. Cl. 702/181

(57) ABSTRACT

A fraud score calculating program primarily for use in determining the possibility of credit card fraud can calculate a score reflecting the reliability of a model created based on Bayesian theory. A model which is stored in a fraud detection model database 120 obtains new authorization data and continues learning as the number of data samples increases. Calculation of the score is performed by a calculation logic provided in a scoring subsystem 110. The sample number data for a case corresponding to the authorization data are obtained from the model, and the probability of the occurrence of fraudulent use is calculated. The reliability of the model is also calculated on the basis of, for example, the number of the registered samples, and a fraud score is calculated using both the calculated probability of the occurrence of fraud and the calculated reliability of the model.

### BACKGROUND OF THE INVENTION

1. Field of the Invention

This invention relates to a fraud score calculating program which, in the calculation of a score determining fraud (hereinafter referred to as a “fraud score”) primarily in the use of credit cards and the like, can calculate a score reflecting the reliability of a model created based on Bayesian theory, a fraud score calculating method using the score calculating program, and a fraud score calculating system for credit cards which uses the score calculating program.

2. Description of the Related Art

When a credit card is used, in order to prevent fraudulent transactions such as by a third party who has found the credit card and pretends to be the owner, it is customary for the store or the like where the card has been used to check with the credit card company to ascertain the credit card balance as well as to do a credit inquiry concerning fraudulent use. In a system for such credit inquiry, it is becoming important to perform highly reliable determination using data on past fraudulent use and the like.

At present, credit card companies use a system which automatically determines a score for the possibility of fraudulent use based on authorization data (data which is sent from the store or the like concerning the owner of the credit card, the amount of the transaction which is requested, etc.). In such systems, it is typical to determine a score using a scoring system which utilizes a neural network using neural theory (see Nonpatent Document 1, for example).

A neural network is leading-edge technology which models the structure and information processing function of nerve cells of the human brain. Special know-how and a large monetary investment are required to construct the system. Accordingly, many credit card companies do not themselves construct a basic system for score determination, but instead typically introduce a general purpose external system for portions relating to a neural network.

However, a scoring system using a neural network has the problems that the logic for making a determination is a black box, so the basis of determination is unclear to the credit card company or the like which utilizes it. In addition, as the user such as the credit card company does not itself create the neural network, it is not easy to reflect trends based on the authorization data for that company. In order to cope with such problems, it is conceivable to construct a scoring system using a Bayesian network which used Bayesian theory, which has recently come to be used in the fields of artificial intelligence and the like instead of a neural network. The basis of Bayesian theory is the probability of occurrence which statistically predicts the probability of occurrence of a certain event.

Nonpatent Document 1

Asano Yoichiro, Suda Yoshinobu, “Introduction of a Fraudulent Use Detection System and Its Effects”, Gekkan Syohishashinyo, Kinzai Institute for Financial Affairs Research Group, May 2000, pages 16-19.

When it is attempted to determine fraudulent use of a credit card based on Bayesian theory, various cases are classified based on the time of use of the credit card, the amount, the store, and the like, and by calculating, for each case, the probability that fraud occurred from past authorization data, a probability of occurrence can be determined. In order to calculate the probability of occurrence, past authorization data are collected, and a model which classifies the data by case is prepared. In this model, the data are classified into as many cases as possible, and by collecting a large amount of authorization data for each case, the reliability of the probability of occurrence can be increased.

When it is attempted to prepare a model which determines fraudulent use based on Bayesian theory in accordance with the above-described concept, it is preferred to input to the model authorization data on actual use of credit cards, and cause the model to perform repeated learning. Accordingly, in order to utilize the model for score determination, it is preferable to carry out a sufficient amount of learning.

However, the reliability of the probability of occurrence increases with the degree of learning by the model, and determination as to whether the model can be used for score determination should not be performed by use of a constant reference value. From this standpoint, it is thought that it is preferable for the difference in reliability which is produced depending on the degree of learning by the model to be reflected in the fraud score.

### SUMMARY OF THE INVENTION

An object of this invention is to cope with such problems and to provide a fraud score calculating program which, in the calculation of a fraud score primarily with respect to the use of credit cards and the like, can calculate a score which reflects the reliability of a model which is prepared based on Bayesian theory.

Another object of this invention is to provide a fraud score calculating method.

Still another object of this invention is to provide a fraud score calculating system for credit cards which uses the score calculating program.

According to one aspect, the present invention solves such problems by providing a score calculating program for calculating a fraud score reflecting reliability which causes a computer to perform a step of obtaining from a storage device the number of samples contained in a case which matches requested data for which score calculation is requested, a step of obtaining from the storage device the number of frauds in the samples contained in the case matching the requested data, a step of calculating the probability of the occurrence of fraud using the number of samples and the number of frauds, a step of obtaining the total number of samples stored in the storage device, a step of obtaining the total number of cases corresponding to the samples stored in the storage device, a step of calculating the reliability of data accumulation using the total number of samples and the total number of cases, and a step of calculating a fraud score using the probability of the occurrence of fraud and the reliability of data accumulation.

According to another aspect of the present invention, a score calculating program for calculating a fraud score reflecting reliability causes a computer to perform a step of obtaining from a storage device the number of samples contained in a case which matches requested data for which score calculation is requested, a step of obtaining from the storage device the number of frauds in the samples contained in the case matching the requested data, a step of calculating the probability of the occurrence of fraud using the number of samples and the number of frauds, a step of obtaining the total number of fraud samples, which are samples corresponding to frauds, stored in the storage device, a step of obtaining the total number of fraud cases containing fraud samples stored in the storage device, a step of calculating the reliability of fraud data accumulation using the total number of fraud samples and the total number of fraud cases, and a step of calculating a fraud score using the probability of the occurrence of fraud and the reliability of fraud data accumulation.

According to another aspect of the present invention, a score calculating program for calculating a fraud score reflecting reliability causes a computer to perform a step of obtaining from the storage device the number of samples contained in a case which matches requested data for which score calculation is requested, a step of obtaining from the storage device the number of frauds in the samples contained in the case matching the requested data, a step of calculating the probability of the occurrence of fraud using the number of samples and the number of frauds, a step of obtaining the total number of samples stored in the storage device, a step of obtaining the total number of cases corresponding to the samples stored in the storage device, a step of calculating the reliability of data accumulation using the total number of samples and the total number of cases, a step of obtaining the total number of fraud samples, which are samples corresponding to frauds, stored in the storage device, a step of obtaining the total number of fraud cases containing fraud samples stored in the storage device, a step of calculating the reliability of fraud data accumulation using the total number of fraud samples and the total number of fraud cases, and a step of calculating a fraud score using the probability of the occurrence of fraud, the reliability of data accumulation, and the reliability of fraud data accumulation.

In these aspects of the present invention, as a model for score calculation, data related to samples classified according to cases is stored in a storage device such as a database. By obtaining the number of samples and the number of frauds in the samples for the corresponding case from the storage device and calculating the probability of the occurrence of fraud, and by further calculating a reliability reflecting the degree of learning by the model and calculating a score from the probability of occurrence while reflecting the reliability thereon, a score which reflects the reliability of the model can be easily obtained. The storage device from which the number of samples and the number of frauds are obtained may be the same database or different databases.

In the above-described aspects of the present invention, the reliability of data accumulation may be calculated using a coefficient which is the total number of cases divided by the total number of samples. The reliability of fraud data accumulation may be calculated using a coefficient which is the total number of fraud cases divided by the total number of fraud samples.

In the model for score calculation, it can be determined that the greater the total number of samples, the greater is the degree of learning and the greater is the reliability. With respect to the classified cases, it can be determined that the greater the number of samples included in one case, the greater is the degree of learning and the greater is the reliability. Accordingly, by using such a coefficient, reliability reflecting the degree of learning can be calculated. The number of samples of interest may be the total number of samples, or it may be limited to those corresponding to fraud.

In the above-described aspects of the present invention, the score may be calculated by multiplying the probability of the occurrence of fraud by the reliability of data accumulation. The score may also be calculated by multiplying the probability of the occurrence of fraud by the reliability of fraud data accumulation.

By virtue of the above-described feature, by lowering the weight given to the probability of occurrence, which is mechanically calculated from the model, as the reliability decreases, the score can be calculated in accordance with the reliability of the calculated probability of occurrence.

In the above-described aspects of the present invention, the fraud determination may be determination of credit card fraud, the requested data may be authorization data, and authorization data concerning past credit card use may be stored in the samples contained in the storage device, and the cases may be classified according to factors contained in the authorization data.

By virtue of the above-described feature, the fraud score calculating program according to the present invention can be used to determine the possibility of fraud in credit card use when the use of a credit card is accepted.

In addition, the present invention provides a fraud score calculating method using a fraud score calculating program according to the present invention. Furthermore, the present invention provides a fraud score calculating system using a fraud score calculating program according to the present invention.

Namely, a fraud score calculating system for calculating a score for determining credit card fraud according to one aspect of the present invention comprises

authorization data storing means for storing authorization data concerning past credit card use and authorization data relating to fraudulent use in this authorization data in such a manner that they are classified in accordance with cases, new authorization data receiving means for receiving new authorization data for use in carrying out fraud score calculation, means for calculating the probability of the occurrence of fraud which determines a case corresponding to the new authorization data and obtains the number of samples of authorization data which correspond to the case and which are stored in the authorization data storing means and the number of frauds in the authorization data corresponding to the case and calculates the probability of the occurrence of fraud, data accumulation reliability calculating means for obtaining the total number of samples in the authorization data stored in the authorization data storing means and the total number of cases corresponding to the authorization data stored in the authorization data storing means and calculating the reliability of data accumulation, and score calculating means for calculating a fraud score for the new authorization data from the probability of the occurrence of fraud and the reliability of data accumulation.

A fraud score calculating system for calculating a score for determining credit card fraud according to another aspect of the present invention comprises authorization data storing means for storing authorization data concerning past credit card use and authorization data relating to fraudulent use in this authorization data in such a manner that they are classified in accordance with cases, new authorization data receiving means for receiving new authorization data for carrying out fraud score calculation, means for calculating the probability of the occurrence of fraud which determines a case corresponding to the new authorization data and obtains the number of samples of authorization data which correspond to the case and which are stored in the authorization data storing means and the number of frauds in the authorization data corresponding to the case and calculates the probability of the occurrence of fraud, fraud data accumulation reliability calculating means for obtaining the total number of fraud samples, which are authorization data corresponding to frauds, stored in the authorization data storing means and the total number of fraud cases containing the fraud samples stored in the authorization data storing means and calculating the reliability of fraud data accumulation, and score calculating means for calculating a fraud score for the new authorization data from the probability of the occurrence of fraud and the reliability of fraud data accumulation.

A fraud score calculating system for calculating a score for determining credit card fraud according to yet another aspect of the present invention comprises authorization data storing means for storing authorization data concerning past credit card use and authorization data relating to fraudulent use in this authorization data in such a manner that they are classified in accordance with cases, new authorization data receiving means for receiving new authorization data for carrying out fraud score calculation, means for calculating the probability of the occurrence of fraud which determines a case corresponding to the new authorization data and obtains the number of samples of authorization data which correspond to the case and which are stored in the authorization data storing means and the number of frauds in the authorization data corresponding to the case and calculates the probability of the occurrence of fraud, data accumulation reliability calculating means for obtaining the total number of samples in the authorization data stored in the authorization data storing means and the total number of cases corresponding to the authorization data stored in the authorization data storing means and calculating the reliability of data accumulation, fraud data accumulation reliability calculating means for obtaining the total number of fraud samples, which are authorization data corresponding to frauds, stored in the authorization data storing means and the total number of fraud cases containing the fraud samples stored in the authorization data storing means and calculating the reliability of fraud data accumulation, and score calculating means for calculating a fraud score for the new authorization data from the probability of the occurrence of fraud and the reliability of data accumulation and the reliability of fraud data accumulation.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a block diagram of a fraud score calculating system for credit cards according to the present invention;

FIG. 2 is a block diagram showing the structure of the fraud score calculating system of FIG. 1 in greater detail;

FIG. 3 is a block diagram showing the flow of score calculation by a fraud score calculating program according to the present invention;

FIG. 4 schematically illustrates an example of a data structure of a fraud detection model used in the fraud score calculating program according to the present invention;

FIG. 5 is a block diagram schematically illustrating the concept of a score calculating formula for use in the fraud score calculating program according to the present invention;

FIG. 6 illustrates a specific example of a score calculating formula for use in the fraud score calculating program according to the present invention; and

FIG. 7 is a flow chart of the fraud score calculating program according to the present invention.

### DESCRIPTION OF PREFERRED EMBODIMENTS

Embodiments of the present invention will be described below in detail while referring to the accompanying drawings. In the following description, the case will be described in which a fraud score calculating program according to the present invention is used for determining the possibility of fraudulent use when the use of a credit card is accepted, but the present invention is not limited to such an embodiment.

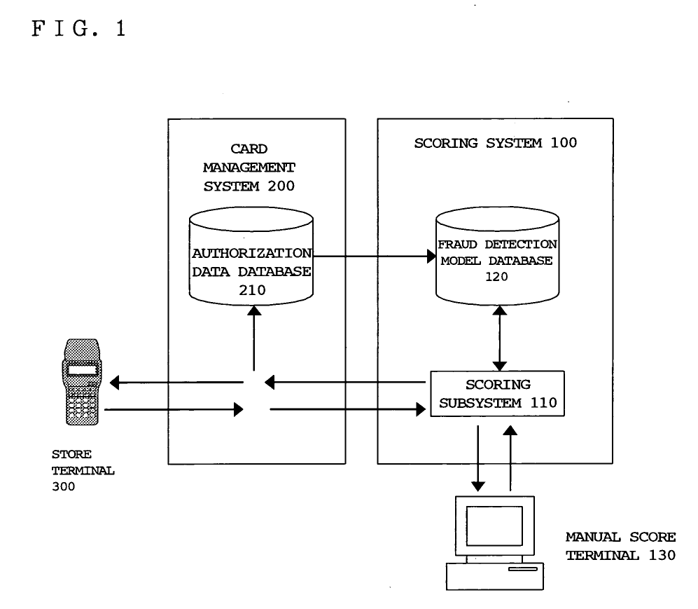

In FIG. 1, a scoring system 100 according to the present invention comprises a scoring subsystem 110 and a fraud detection model database 120. It can be operated by a manual score terminal 130. The fraud detection model database 120 obtains authorization data from an authorization data database 210 of a card management system 200 which is managed by a credit card company. When there is an inquiry from a store terminal 300 at the time of credit card use, the scoring subsystem 110 determines a fraud score from authorization data received through the card management system 200 and sends the score back to the card management system 200, and the card management system 200 sends the result of the inquiry, which is determined by the score, to the store terminal 300.

Calculation of the score in the scoring subsystem 110 is carried out by referring to the fraud detection model database 120. The fraud detection model database 120 stores the number of samples and the number of frauds corresponding to cases which are classified based on factors, such as the time and the amount, contained in the authorization data. The scoring subsystem 110 obtains data regarding the number of samples and the number of frauds (hereinafter referred to as “sample number data”) of a case corresponding to the authorization data for which a request for determination was received, and calculates a score.

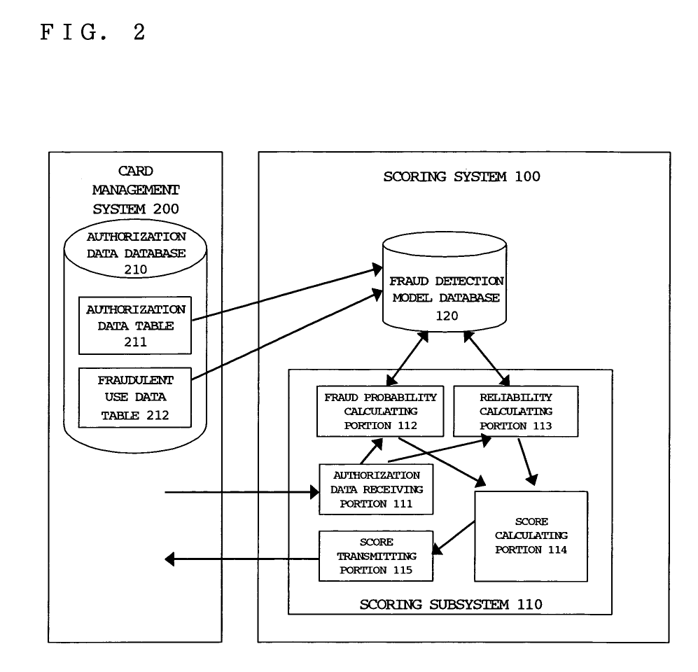

FIG. 2 shows the structure of the fraud score calculating system for credit cards according to the present invention in greater detail. The fraud detection model database 120 obtains authorization data from an authorization data table 211 of the authorization data database 210 in the card management system 200. For the authorization data which is obtained, the fraud detection model database 120 determines the cases corresponding to each of factors such as the time and amount, and the number of samples is stored in the fraud detection model database 120. In addition, the fraud detection model database 120 obtains authorization data corresponding to fraudulent use from the fraudulent use data table 212 of the authorization data database 210 in the card management system 200. For the obtained authorization data, it makes a determination of the cases corresponding to factors in the data such as the time and amount, and the number of samples corresponding to fraudulent use is stored in the fraud detection model database 120.

The scoring subsystem 110 has an authorization data receiving portion 111, a fraud probability calculating portion 112, a reliability calculating portion 113, a score calculating portion 114, and a score transmitting portion 115. When the authorization data receiving portion 111 receives authorization data for which a request for determination has been received, the fraud probability calculating portion 112 refers to the fraud detection model database 120 and calculates the probability of the occurrence of fraud for a case corresponding to the authorization data. The reliability calculating portion 113 refers to the fraud detection model database 120 and calculates the degree of learning of the model. The score calculating portion 114 obtains the probability of the occurrence of fraud calculated in the fraud probability calculating portion 112 and the reliability calculated in the reliability calculating portion 113 and calculates a score. The calculated score is sent from the score transmitting portion 115 to the card management system 200.

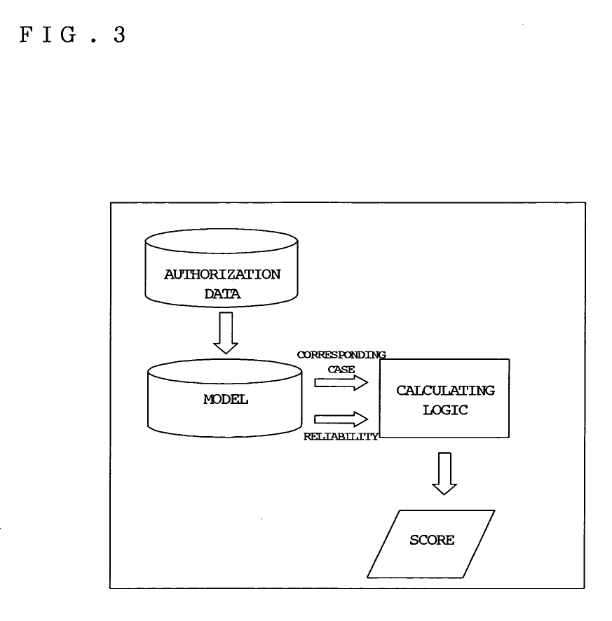

Calculation of the score by the fraud score calculating program according to the present invention is carried out as shown in FIG. 3. A model which is stored in the fraud detection model database 120 obtains new authorization data from time to time, and it continues learning as the number of samples increases. The score is calculated by calculating logic in the scoring subsystem 110. The calculating logic obtains sample number data for the corresponding case from the model and calculates the probability of occurrence of fraudulent use, and in addition obtains the number of stored samples and other data from the model and calculates the reliability of the model. In this manner, the calculating logic reflects the reliability in the calculated probability of occurrence, and it calculates the score.

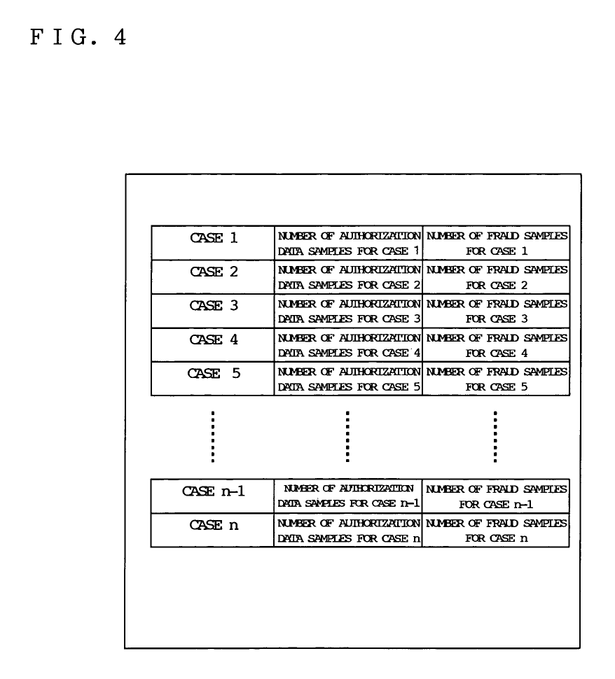

FIG. 4 shows an example of the structure of the authorization data stored in the model. As shown in this figure, based on factors contained in the authorization data, cases are set in the model which is stored in the fraud detection model database 120. In a record for each case, the number of samples of corresponding authorization data and the number of samples of fraudulent use are recorded. The cases are classified according to each of the factors contained in the authorization data or according to combinations of a plurality of factors. For example, the cases “use from 9 AM-12 noon” and “use from 9 AM-12 noon of at most 10,000 yen” are provided, and the number of samples of authorization data and the number of samples of fraudulent uses are recorded for each case.

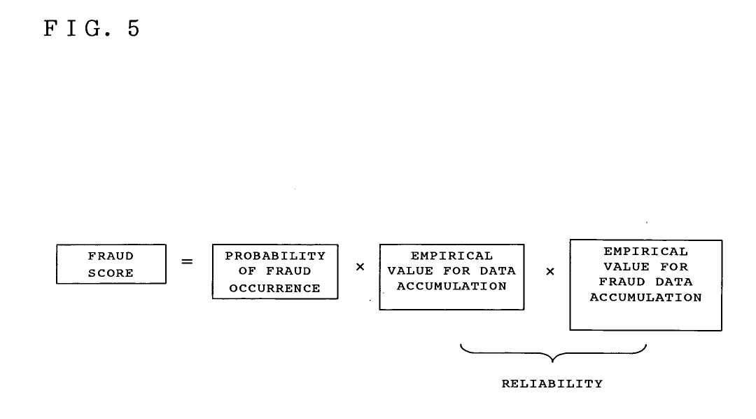

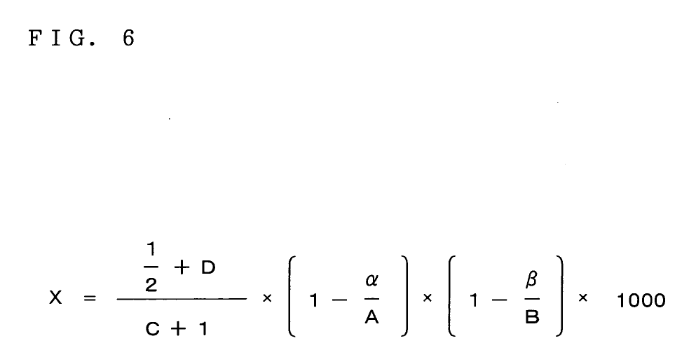

Calculation of the score by the calculating logic of FIG. 3 is performed on the basis of a score calculating formula shown in FIG. 5. FIG. 6 shows a concrete example of the score calculating formula. The symbols in FIG. 6 have the following meanings.

A: the number of accumulated data samples

B: the number of data samples in the accumulated data for which fraudulent use was determined

C: the number of data samples in the case matching the received authorization data

D: the number of fraud samples in the case matching the received authorization data

α: the number of cases included in the accumulated data

β: the number of cases for which a determination of fraudulent use was made out of the cases contained in the accumulated data

X: a score showing the possibility of fraudulent use

As shown in FIG. 5, which illustrates the theory of a score calculating formula, the score is calculated by multiplying the probability of the occurrence of fraud by the reliability, but first the probability of the occurrence of fraud is calculated. Specifically, as shown by the example in FIG. 6, it is found by dividing the number of samples of fraudulent use by the total number of data samples in a case matching the received authorization data. In the formula for calculating the probability of occurrence, 1 is added to the denominator and ½ is added to the numerator. In order to perform this calculation, the fraud probability calculating portion 112 of FIG. 2 obtains the number of fraud samples and the total number of data samples for the cases matching the authorization data received from the fraud detection database 120.

Next, the reliability is calculated. As the reliability, an empirical value based on all the accumulated data may be used, or an empirical value based on the accumulated data pertaining to fraudulent use may be used. Alternatively, a value obtained by multiplying the two may be used as the reliability.

Specifically, as shown in FIG. 6, the reliability may be found by subtracting, from 1, a value obtained by dividing the number of cases contained in the accumulated data by the total number of samples in the accumulated data, or a value obtained by dividing the number of cases for which a determination of fraudulent use was made by the total number of data samples for which a determination of fraudulent use was made. According to such a formula, as the number of accumulated data samples increases, or as the number of data samples included in each case increases, the higher is the value to which the reliability can be set.

The value used for reliability can be either an empirical value for data accumulation of all data or an empirical value for data accumulation of data related to fraudulent use, either of which is calculated as described above, but in order to perform more accurate calculation of reliability, it is preferable to use a value obtained by multiplying both values.

In order to perform these calculations, the reliability calculating portion 113 of FIG. 2 obtains, from the fraud detection model database 120, the number of cases contained in the data accumulated and the total number of data samples in the accumulated data, or the number of cases for which a determination of fraudulent use was made among the cases in the accumulated data and the total number of samples for which a determination of fraudulent use were made.

Finally, the probability of the occurrence of fraud is multiplied by the reliability, and a score is calculated. When the score is calculated as one having a maximum value of 1000, as shown in FIG. 6, the value obtained by multiplying the probability of occurrence of fraud by the reliability is multiplied by 1000.

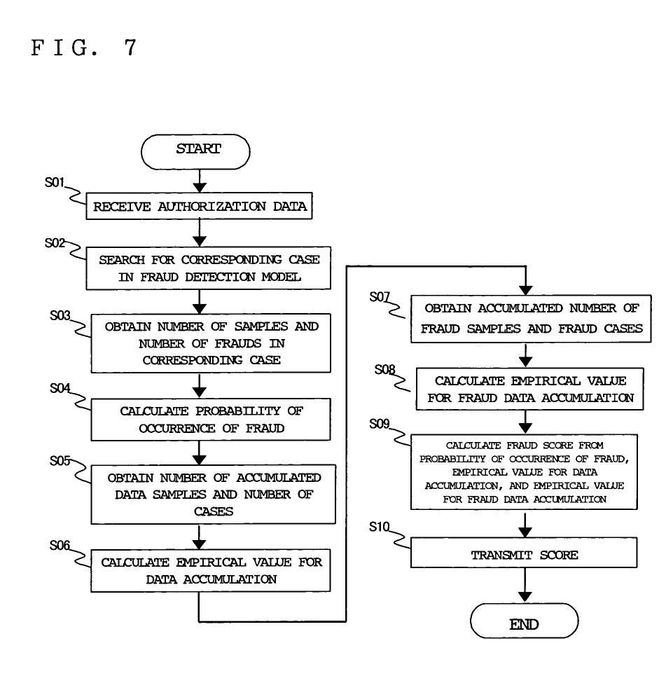

The flow of the fraud score calculating program according to the present invention will be explained using the flow chart of FIG. 7. First, authorization data for which a request was received for a score relating to the probability of fraud is sent from the system of the credit card company or the like (S01). Factors contained in the authorization data are distinguished, and a corresponding case in the fraud detection model is searched for (S02). When a corresponding case has been specified, the number of data samples for the corresponding case, and of that number, the number of data samples for fraudulent use, are obtained from the fraud detection model (S03). From these numbers, the probability of the occurrence of fraud is calculated (S04).

Next, the total number of accumulated data samples and the number of cases contained in the accumulated data are obtained from the fraud detection model (S05), and an empirical value for data accumulation is calculated from these numbers (S06). Then, the total number of accumulated data samples for fraudulent use and the number of cases including data related to fraudulent use in the accumulated data are obtained from the fraud detection model (S07), and an empirical value for fraud data accumulation is calculated from these numbers (S08).

Finally, a fraud score is calculated by multiplying the probability of the occurrence of fraud which is calculated in the above manner by the reliability, which is an empirical value for data accumulation and an empirical value for fraud data accumulation (S09), and the calculated score is sent to the system of the credit card company or the like (S10).

According to this invention, when calculating a fraud score primarily with respect to the use of credit cards or the like, a score which reflects reliability which indicates the degree of learning of a model which is prepared based on Bayesian theory can be calculated. The score which is calculated here is determined on the basis of the two aspects of the probability of occurrence and reliability, so compared to a general score based only on a probability of occurrence by Bayesian theory, a score of higher reliability can be provided.

Obviously, numerous modifications and variations of the present invention are possible in light of the above teachings. It is therefore to be understood that within the scope of the appended claims, the present invention may be practiced otherwise than as specifically described herein.

What is claimed is:

1. A score calculating program for calculating a fraud score reflecting reliability which causes a computer to perform
a step of obtaining from a storage device the number of samples contained in a case which matches requested data for which score calculation is requested,
a step of obtaining from the storage device the number of frauds in the samples contained in the case matching the requested data,
a step of calculating the probability of the occurrence of fraud using the number of samples and the number of frauds,
a step of obtaining the total number of samples stored in the storage device,
a step of obtaining the total number of cases corresponding to the samples stored in the storage device,
a step of calculating the reliability of data accumulation using the total number of samples and the total number of cases, and
a step of calculating a fraud score using the probability of the occurrence of fraud and the reliability of data accumulation.

2. A score calculating program for calculating a fraud score reflecting reliability which causes a computer to perform
a step of obtaining from a storage device the number of samples contained in a case which matches requested data for which score calculation is requested,
a step of obtaining from the storage device the number of frauds in the samples contained in the case matching the requested data,
a step of calculating the probability of the occurrence of fraud using the number of samples and the number of frauds,
a step of obtaining the total number of fraud samples, which are samples corresponding to frauds, stored in the storage device,
a step of obtaining the total number of fraud cases containing fraud samples stored in the storage device,
a step of calculating the reliability of fraud data accumulation using the total number of fraud samples and the total number of fraud cases, and
a step of calculating a fraud score using the probability of the occurrence of fraud and the reliability of fraud data accumulation.

3. A score calculating program for calculating a fraud score reflecting reliability which causes a computer to perform
a step of obtaining from a storage device the number of samples contained in a case which matches requested data for which score calculation is requested,
a step of obtaining from the storage device the number of frauds in the samples contained in the case matching the requested data,
a step of calculating the probability of the occurrence of fraud using the number of samples and the number of frauds,
a step of obtaining the total number of samples stored in the storage device,
a step of obtaining the total number of cases corresponding to the samples stored in the storage device,
a step of calculating the reliability of data accumulation using the total number of samples and the total number of cases,
a step of obtaining the total number of fraud samples, which are samples corresponding to frauds, stored in the storage device,
a step of obtaining the total number of fraud cases containing fraud samples stored in the storage device,
a step of calculating the reliability of fraud data accumulation using the total number of fraud samples and the total number of fraud cases, and
a step of calculating a fraud score using the probability of the occurrence of fraud, the reliability of data accumulation, and the reliability of fraud data accumulation.

4. A score calculating program as claimed in claim 1 wherein the reliability of data accumulation is calculated using a coefficient which is the total number of cases divided by the total number of samples, and the score is calculated by multiplying the probability of the occurrence of fraud by the reliability of data accumulation.

5. A score calculating program as claimed in claim 2 wherein the reliability of fraud data accumulation is calculated using a coefficient which is the total number of fraud cases divided by the total number of fraud samples, and the score is calculated by multiplying the probability of the occurrence of fraud by the reliability of fraud data accumulation.

6. A score calculating program as claimed in claim 3 wherein the reliability of data accumulation is calculated using a coefficient which is the total number of cases divided by the total number of samples, the reliability of fraud data accumulation is calculated using a coefficient which is the total number of fraud cases divided by the total number of fraud samples, and the score is calculated by multiplying the probability of the occurrence of fraud by the reliability of data accumulation and the reliability of fraud data accumulation.

7. A score calculating method for calculating a fraud score reflecting reliability, comprising
a step in which a computer obtains from a storage device the number of samples contained in a case which matches requested data for which score calculation is requested,
a step in which the computer obtains from the storage device the number of frauds in the samples contained in the case matching the requested data,
a step in which the computer calculates the probability of the occurrence of fraud using the number of samples and the number of frauds,
a step in which the computer obtains the total number of samples stored in the storage device,
a step in which the computer obtains the total number of cases corresponding to the samples stored in the storage device,
a step in which the computer calculates the reliability of data accumulation using the total number of samples and the total number of cases, and
a step in which the computer calculates a fraud score using the probability of the occurrence of fraud and the reliability of data accumulation.

8. A score calculating method for calculating a fraud score reflecting reliability, comprising
a step in which a computer obtains from a storage device the number of samples contained in a case which matches requested data for which score calculation is requested,
a step in which the computer obtains from the storage device the number of frauds in the samples contained in the case matching the requested data,
a step in which the computer calculates the probability of the occurrence of fraud using the number of samples and the number of frauds,
a step in which the computer obtains the total number of fraud samples, which are samples corresponding to frauds, stored in the storage device,
a step in which the computer obtains the total number of fraud cases including fraud samples stored in the storage device,
a step in which the computer calculates the reliability of fraud data accumulation using the total number of fraud samples and the total number of fraud cases, and
a step in which the computer calculates a fraud score using the probability of the occurrence of fraud and the reliability of fraud data accumulation.

9. A score calculating method for calculating a fraud score reflecting reliability, comprising
a step in which a computer obtains from a storage device the number of samples contained in a case which matches requested data for which score calculation is requested,
a step in which the computer obtains from the storage device the number of frauds in the samples contained in the case matching the requested data,
a step in which the computer calculates the probability of the occurrence of fraud using the number of samples and the number of frauds,
a step in which the computer obtains the total number of samples stored in the storage device,
a step in which the computer obtains the total number of cases corresponding to the samples stored in the storage device,
a step in which the computer calculates the reliability of data accumulation using the total number of samples and the total number of cases,
a step in which the computer obtains the total number of fraud samples, which are samples corresponding to frauds, stored in the storage device,
a step in which the computer obtains the total number of fraud cases containing fraud samples stored in the storage device,
a step in which the computer calculates the reliability of fraud data accumulation using the total number of fraud samples and the total number of fraud cases, and
a step in which the computer calculates a fraud score using the probability of the occurrence of fraud and the reliability of data accumulation and the reliability of fraud data accumulation.

10. A score calculating method as claimed in claim 7 wherein the reliability of data accumulation is calculated using a coefficient which is the total number of cases divided by the total number of samples, and the score is calculated by multiplying the probability of the occurrence of fraud by the reliability of data accumulation.

11. A score calculating method as claimed in claim 8 wherein the reliability of fraud data accumulation is calculated using a coefficient which is the total number of fraud cases divided by the total number of fraud samples, and the score is calculated by multiplying the probability of the occurrence of fraud by the reliability of fraud data accumulation.

12. A score calculating method as claimed in claim 9 wherein the reliability of data accumulation is calculated using a coefficient which is the total number of cases divided by the total number of samples, the reliability of fraud data accumulation is calculated using a coefficient which is the total number of fraud cases divided by the total number of fraud samples, and the score is calculated by multiplying the probability of the occurrence of fraud by the reliability of data accumulation and the reliability of fraud data accumulation.

13. A fraud score calculating system for calculating a score for determining credit card fraud, comprising
authorization data storing means for storing authorization data concerning past credit card use and authorization data relating to fraudulent use in this authorization data in such a manner that they are classified in accordance with cases,
new authorization data receiving means for receiving new authorization data for use in carrying out fraud score calculation,
means for calculating the probability of the occurrence of fraud which determines a case corresponding to the new authorization data and obtains the number of samples of authorization data which correspond to the case and which are stored in the authorization data storing means and the number of frauds in the authorization data corresponding to the case and calculates the probability of the occurrence of fraud,
data accumulation reliability calculating means for obtaining the total number of samples in the authorization data stored in the authorization data storing means and the total number of cases corresponding to the authorization data stored in the authorization data storing means and calculating the reliability of data accumulation, and
score calculating means for calculating a fraud score for the new authorization data from the probability of the occurrence of fraud and the reliability of data accumulation.

14. A fraud score calculating system for calculating a score for determining credit card fraud, comprising
authorization data storing means for storing authorization data concerning past credit card use and authorization data relating to fraudulent use in this authorization data in such a manner that they are classified in accordance with cases,
new authorization data receiving means for receiving new authorization data for carrying out fraud score calculation,
means for calculating the probability of the occurrence of fraud which determines a case corresponding to the new authorization data and obtains the number of samples of authorization data which correspond to the case and which are stored in the authorization data storing means and the number of frauds in the authorization data corresponding to the case and calculates the probability of the occurrence of fraud,
fraud data accumulation reliability calculating means for obtaining the total number of fraud samples, which are authorization data corresponding to frauds, stored in the authorization data storing means and the total number of fraud cases containing the fraud samples stored in the authorization data storing means and calculating the reliability of fraud data accumulation, and
score calculating means for calculating a fraud score for the new authorization data from the probability of the occurrence of fraud and the reliability of fraud data accumulation.

15. A fraud score calculating system for calculating a score for determining credit card fraud, comprising
authorization data storing means for storing authorization data concerning past credit card use and authorization data relating to fraudulent use in this authorization data in such a manner that they are classified in accordance with cases,
new authorization data receiving means for receiving new authorization data for carrying out fraud score calculation,
means for calculating the probability of the occurrence of fraud which determines a case corresponding to the new authorization data and obtains the number of samples of authorization data which correspond to the case and which are stored in the authorization data storing means and the number of frauds in the authorization data corresponding to the case and calculates the probability of the occurrence of fraud,
data accumulation reliability calculating means for obtaining the total number of samples in the authorization data stored in the authorization data storing means and the total number of cases corresponding to the authorization data stored in the authorization data storing means and calculating the reliability of data accumulation,
fraud data accumulation reliability calculating means for obtaining the total number of fraud samples, which are authorization data corresponding to frauds, stored in the authorization data storing means and the total number of fraud cases containing the fraud samples stored in the authorization data storing means and calculating the reliability of fraud data accumulation, and
score calculating means for calculating a fraud score for the new authorization data from the probability of the occurrence of fraud and the reliability of data accumulation and the reliability of fraud data accumulation.

16. A fraud score calculating system as claimed in claim 13 wherein the reliability of data accumulation is calculated using a coefficient which is the total number of cases divided by the total number of samples, and the score is calculated by multiplying the probability of the occurrence of fraud by the reliability of data accumulation.

17. A fraud score calculating system as claimed in claim 14 wherein the reliability of fraud data accumulation is calculated using a coefficient which is the total number of fraud cases divided by the total number of fraud samples, and the score is calculated by multiplying the probability of the occurrence of fraud by the reliability of fraud data accumulation.

18. A fraud score calculating system as claimed in claim 15 wherein the reliability of data accumulation is calculated using a coefficient which is the total number of cases divided by the total number of samples, the reliability of fraud data accumulation is calculated using a coefficient which is the total number of fraud cases divided by the total number of fraud samples, and the score is calculated by multiplying the probability of the occurrence of fraud by the reliability of data accumulation and the reliability of fraud data accumulation.
